(19) United States
(12) Patent Application Publication
(10) Pub. No.: US 2007/0111714 A1
(43) Pub. Date: May 17, 2007

(54) Methods and apparatus for recognizing home network provider of incoming wireless calls

(75) Inventor: Michael Edwards, Madison, MS (US)

Correspondence Address: Merchant & Gould P.C., P.O. Box 2903, Minneapolis, MN, 55402-0903, US

(73) Assignee: BellSouth Intellectual Property Corporation

(21) Appl. No.: 11/273,546

(22) Filed: Nov. 14, 2005

(51) Int. Cl. H04M 3/42

(52) U.S. Cl. 455/415

(57) ABSTRACT

In a cellular wireless system, a handset identifies and displays the home network provider for an incoming call. If that home network provider is different from the home network provider for the called handset, the user of that handset is notified and may decide not to accept an incoming call that may incur an airtime charge.

### FIELD OF THE INVENTION

This invention relates in general to wireless cellular service, and relates in particular to enabling users of cellular phones to determine whether an incoming call is originating from the user's home network provider before the user decides to accept the incoming call.

### BACKGROUND

Most cellular telephone users subscribe to service plans in which, for a predetermined fee, a specific provider of cellular services (hereinafter the “home service provider”) offers the subscriber a certain number of air-time minutes each month. The fee may be charged to the subscriber monthly or may be prepaid, depending on the subscriber's service plan. In either case, however, the duration of both outgoing calls originated by the subscriber and incoming calls to the subscriber's cellular number usually are charged against the monthly air-time for that subscriber. If the subscriber's monthly air-time usage (combined incoming and outgoing calls) exceeds the predetermined allotment, the subscriber typically will incur a per-minute charge for that excess air-time usage.

To ameliorate the effect of air-time usage and to attract more users, some wireless carriers offer calling plans wherein members of the plan may call another subscriber on the same wireless home service network, at no per-minute charge or other fee beyond the normal monthly fees for the wireless services of both subscribers. Such so-called family calling plans thus allow a subscriber to make or receive unlimited calls to another subscriber on the same cellular home service network. However, most wireless users are unlikely to know whether an incoming call is originating from another subscriber on that user's own home network and thus may be reluctant to accept incoming calls that might exceed their remaining air-time allotment.

### SUMMARY OF THE INVENTION

The present invention addresses the above and other problems by providing a method that includes comparing a predetermined home network provider for the called wireless device with the home network provider of an incoming call to the called wireless device. If the home network identified for the incoming call bears a certain relation to the home network for the called wireless device, an indication of that certain relation is provided to at least one of the called wireless device and the originating device for that incoming call. The user of the called wireless device, knowing the network provider for that incoming call, may then decide whether to accept that call.

Stated in somewhat greater detail, a method according to an embodiment of the present invention provides the called wireless device with distinct kinds of indications in response to determining whether the incoming call is from a caller using the same home network as the called device. Thus, the called device can provide a first indication if a certain relation between network providers is determined to exist, and can provide a second kind of indication in response to determining that the certain relation between network providers is absent.

According to an alternative embodiment of the present invention, the device originating a wireless call can receive an indication whether the home network provider for the called device bears a predetermined relation to the home network provider for the originating device. By way of example, the originating device can give the caller an option not to complete the call to the called wireless device if the network providers are determined to be different, so that the originating call does not terminate to the called wireless device as an incoming call chargeable to the air-time minutes for the caller or the called parties.

According to a further disclosed embodiment of the present invention, either or both of the originating device and the called wireless device may store data corresponding to phone-book profiles for individuals being called. These profiles can include, in addition to the customary telephone number and name of the person, an indication whether that number is “in-network”, that is, whether the number is associated with a wireless device on the same home network provider as the wireless device storing the profile.

Other features and advantages of the present invention will become more readily apparent from the following discussion of preferred embodiments.

### BRIEF DESCRIPTION OF DRAWING

FIG. 1 is a functional diagram showing portions of a telephone system including cellular providers.

FIG. 2 is a block diagram showing elements of a wireless handset according to the disclosed embodiment of the present invention.

FIG. 3 shows typical screen displays of an address-book entry and of an incoming call for a wireless handset as in FIG. 2 and equipped according to a disclosed embodiment of the present invention.

FIG. 4 shows a screen display associated with an originating call on a wireless handset as in FIG. 2 according to a disclosed embodiment of the present invention.

FIG. 5 represents operational flow for recognizing and displaying the home network provider of an incoming call according to a disclosed embodiment of the present invention.

FIG. 6 represents operational flow at an originating wireless handset, for recognizing and displaying the home network provider of a called party according to the disclosed embodiment.

### DETAILED DESCRIPTION OF DISCLOSED EMBODIMENT

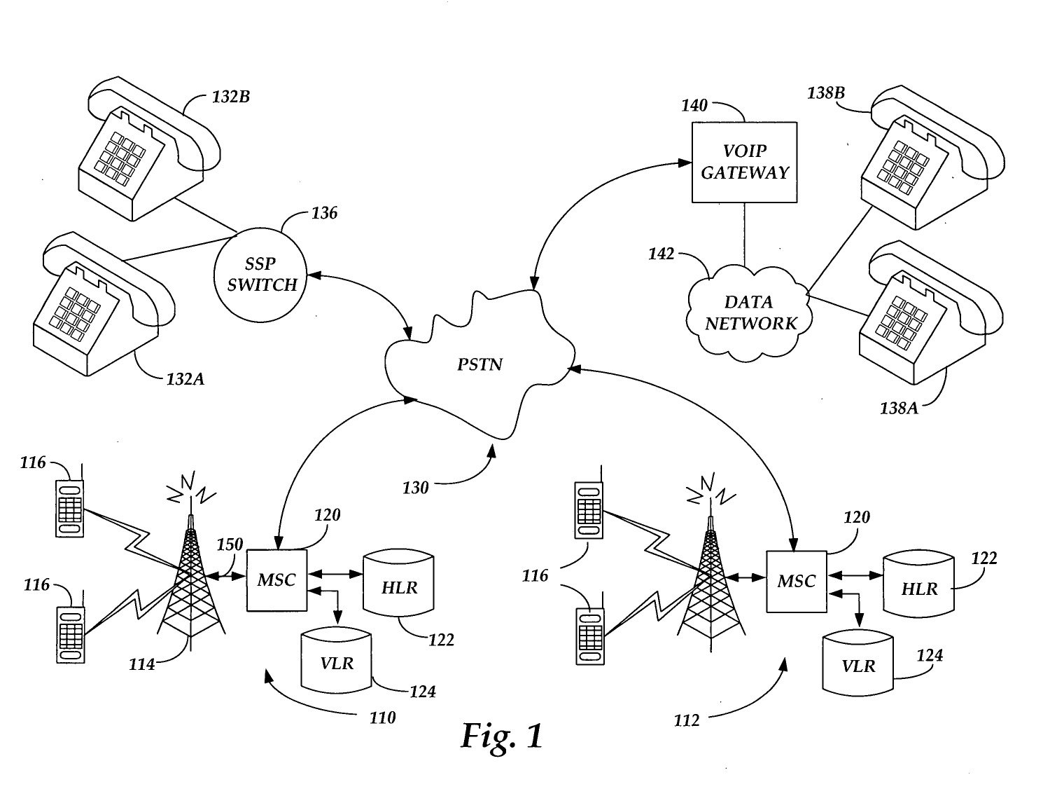

FIG. 1 illustrates a typical telephone network according to an embodiment of the invention and including two exemplary cell sites 110 and 112. Each cell site 110 and 112 includes a radio tower 114 and associated RF equipment for communicating with exemplary handsets 116. As is known to those skilled in the art, each cell site 110, 112 interconnects with a mobile switching center 120 that bridges the mobile telephone network with the public switched telephone network (PSTN) indicated generally at 130 in FIG. 1, and includes a home location register (HLR) 122 functioning as a database of subscriber information and maintained by the subscribers' home service provider of wireless services. Each mobile switching center 120 also includes a visitor location register (VLR) 124 functioning as a database for handsets identified as roaming in a cell maintained by a provider of wireless services other than the home provider for that handset.

Subscribers using a wireless handset such as the handset 116A can initiate and receive calls with other wireless subscribers in the same cell site or in a different cell site, and can also initiate and receive calls from wireline telephones 132A, 132B connected to the PSTN 130 through switching apparatus including an SSP switch 136. The handsets 116A, 116B can also initiate and receive calls from VOIP telephone sets 138A, 138B functionally connecting to a VOIP gateway 140 through a data network 142, as is known to those skilled in the art.

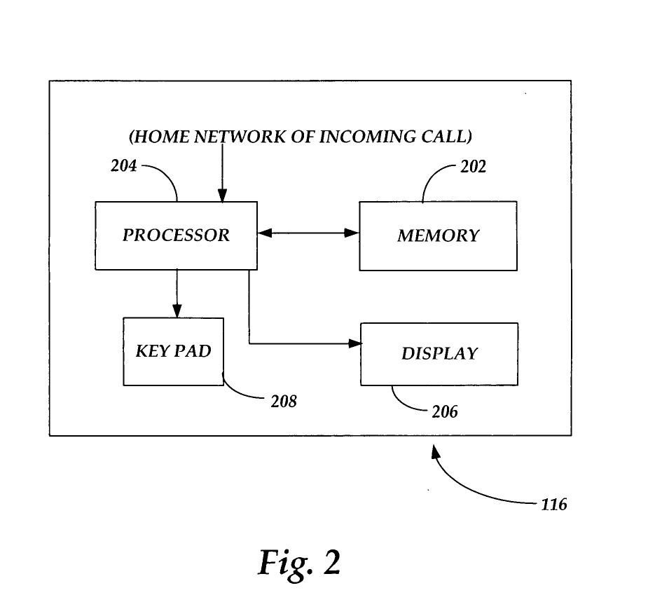

FIG. 2 shows a schematic representation of selected elements in a typical handset 116 and relevant to the disclosed embodiment of the present invention. Those elements include a memory 202 connected to a processor 204, a display 206 receiving and displaying selected information from the processor 204, and a keypad 208 also connected to the processor 204. The processor 204 is shown as receiving a signal with an incoming call including information identifying the home network provider for the incoming call. The memory 202 of the handset 116 may comprise any kind of memory suitable for the requirements of wireless handsets 116, such as a memory chip fixed within the handset 116 and a mobile ID chip selectably removable from the handset 116, as is known to those skilled in the art. The memory 202 receives and stores information relating to the particular wireless handset 116, including the identification number unique to that handset 116, the home network provider for that handset 116 and the telephone number assigned to the handset 116 by the home network provider, and also contains user-programmable information such as the names and telephone numbers entered into the address-book function for the handset 116. Moreover, the memory 202 also may contain information concerning the home network providers of address-book entries, according to the disclosed embodiment of the present invention as described below in greater detail.

Those skilled in the art will understand that FIG. 2 is not a schematic view of a complete wireless handset 116 and that such handsets 116 contain additional structural and functional components required for their operation.

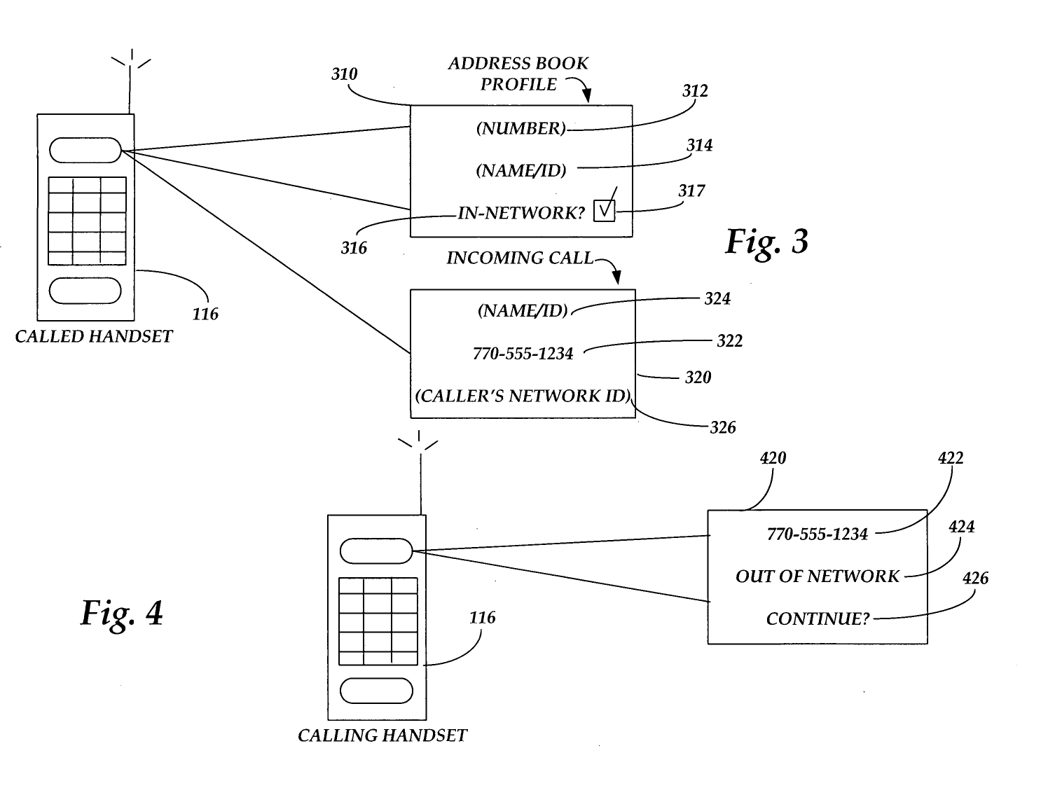

FIG. 3 depicts typical messages appearing on the display of a wireless handset 116 according to a disclosed embodiment of the present invention. The display 310 represents an address-book profile being entered into the handset 116. Currently, when a handset user programs a phone number into the handset 116, the user may also associate a word or name with that number, e.g., designating whether that number is a home phone or a cell phone, the work or office number of a person, or the like. In the display 310, the number being programmed into the address book appears at 312 and the name or other identifying information associated with that person is entered in the usual manner to appear at 314. In addition to the number and name entered into the address book profile for a particular party, the handset 116 according to the disclosed embodiment also enables the user to enter whether or not the party subscribes to the same home network provider as the user. That indication appears in the display 310 at 316, where the message “in-network” appears adjacent a check box 317. The user, after entering the number and the name or ID of a person in the address book profile, can indicate whether that person is in the same network as the user, that entry shown by the check mark in the box 317 of FIG. 3. When the party with that number thereafter calls the handset 116, the called handset 116 typically receives the calling number as part of incoming-call signaling and compares that incoming number with stored numbers 312 in the memory 202. If a match is determined to exist, the called handset 116 determines whether the in- network box 317 associated with that number was previously set and, if so, the display 320 presents the network identifier associated with that caller. That network identifier may, by way of example and without limitation, display a logo associated with the predetermined home network common to both the called handset 116 and the caller's home network, or a brief text message stating that the incoming call is in-network. Alternatively, the called handset 116 may provide an alert only if the calling party is not in the user's home network. In either case, the user of the called handset 116 can accept the incoming call in the usual manner.

The display 320 shown in FIG. 3 illustrates a typical display for an incoming call according to a disclosed embodiment of the present invention. That display 320 includes the number 322 of the caller, the name or other identifier 324 of that caller (if that information is in the address book profile of the called handset 116 or is otherwise available to the called handset), and information at 326 identifying the network of the caller. Presented with information as in the display 320, a user of the called handset 116 knows whether accepting that call will be charged against the user's airtime and can decide whether to accept the call.

FIG. 4 shows the wireless handset 116 equipped according to the disclosed embodiment and showing a display 420 in response to an outgoing call placed by the user of that handset 116. It should be understood that the calling handset 116 shown in FIG. 4 may be identical to the called handset 116 in FIG. 3, with the outgoing-call display 420 substituting for the displays 310 and 320 in FIG. 3 because of the different mode of usage (outgoing call vs. incoming call) depicted for the calling handset 116. In response to placing an outgoing call with the calling handset 116, the display shows the number 422 of the party being called. That number may be keyed into the calling handset 116 by the caller, or the number may have been previously programmed into the user's address book and selected by the user for making the present call. When the caller initiates an outgoing call with the calling handset 116, assuming that call is to another cellular phone, a signal is returned to the calling handset 116 according to the disclosed embodiment of the present invention, indicating the home network associated with the number 422 being called. That home-network information may come from the home network of the called party (for example, the HLR 122 of the home network 112 shown in FIG. 1), from a separate database of subscribers maintained for the purpose, or from home-network information obtained from the handset of the called party in response to placing the outgoing call. However, according to the disclosed embodiment, that outgoing call is not immediately completed to initiate ringing at the called handset 116 associated with the number 422 being called. Instead, the calling handset 116 compares the returned identify of the home network for the called party with the caller's own home network. If this comparison indicates that the called party is not in the same network as the caller or that different network providers for the parties otherwise do not have a predetermined relation with each other, the message “Out of Network” or a message of similar import appears at 424 on the display 420 of the calling handset. That display 420 also prompts the caller, at 426, to indicate whether or not the caller desires to continue that outgoing call. If the caller does wish to continue a call and enters the corresponding selection on the calling handset 116, the calling handset 116 then sends a signal that initiates ringing at the handset of the called party. The called handset 116 associated with the called number 422, if equipped according to the handset 116 depicted in FIG. 3, will then display the name and network identification of the caller as shown at 320.

Reverting to FIG. 4, if the caller decides not to continue the call in response to the query 426, that call ends without completion in response to the corresponding entry in the calling handset 116 that is, without initiating ringing at the handset of the called party.

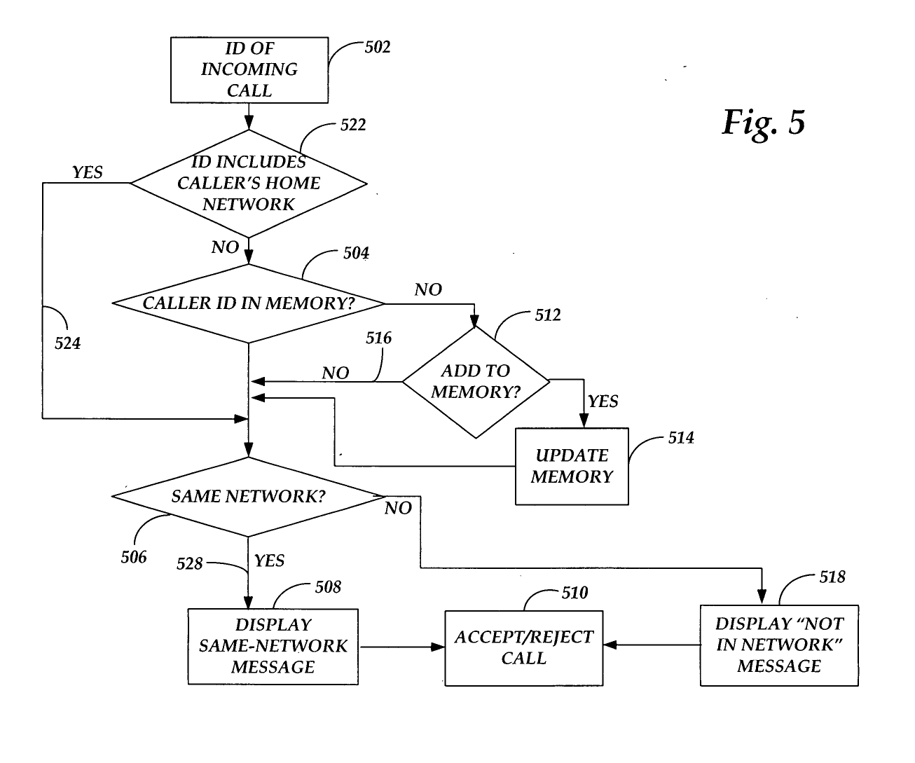

FIG. 5 illustrates exemplary logic by which the processor 204 handles incoming wireless calls to the handset 116, according to the disclosed embodiment of the present invention. The called handset 116 receives a signal of an incoming call as shown at 502 and that signal may include information identifying the home network of the caller according to the present invention, as well as the telephone number of the caller. According to one disclosed embodiment, the identification of the caller's home network is obtained from existing resources such as the HLR 122 associated with that caller's MSR, if the incoming call originates from the caller's home network. If the incoming call was placed while the caller was roaming, the home network may be obtained from the VLR 124 of the MSR where that call originates. Alternatively, one or several separate databases of information concerning the home network providers associated will cellular wireless services may be provided within the system.

If the incoming-call signaling identifies only the number of the calling party without identifying the caller's home network, that home network may nonetheless be recognizable according to a disclosed embodiment. Referring to FIG. 5, the called handset 116 determines at 522 whether the incoming call includes information identifying the home network of the caller. If that information is not present, the processor 204 has logic to determine at 504 whether the incoming-call telephone number is a telephone number previously stored in the memory 202 (FIG. 2) of the called handset 116 and whether a profile already exists for the caller in the address book of the called handset 116. If that profile does exist, including the home-network identification of the caller, that network identification is compared at 506 with the home network identification of the called handset 116, which is typically programmed into the called handset 116 at the time of activation, to determine whether or not the home networks of the caller and the called party bear a predetermined relation. That predetermined relation may mean that both parties use the same home network. In addition, the determination of different home networks for the caller and called parties may satisfy the predetermined-relation requirement if the providers of those home networks have agreed, for example, to provide reciprocal free incoming calls to their subscribers.

If the comparison at 506 shows that such a predetermined relation exists, the processor 204 of the called handset 116 is commanded to display a suitable same-network message as indicated at 508 in FIG. 5. That same-network message may be any suitable wording that can fit within the physical limitations of the display 206 on the called handset, or may include or be substituted by a logo or other indicia that the user of the handset is likely to identify as indicating the incoming call may be accepted without incurring airtime charges. The user of the called handset may then accept or reject the incoming call as at 510, in the customary manner.

Returning to 504, if the telephone number associated with the caller is not in the address-book memory of the called handset, the processor 204 of the handset 116 may display a prompt at 512 asking whether the user wants to add that caller's number and home network to the address-book memory of the called handset 116. If the user answers that prompt in the affirmative, the processor 204 updates the memory at 514 and the logic flow returns to 506 to determine whether the predetermined relation exists between the home networks of the caller and called parties. If the user decides not to add the call to the address book of the called handset, the logic returns at 516 to the same network comparison as shown at 506.

If the network comparison at 506 determines that the home network provider for the incoming call is not the same as the home network for the called handset or otherwise lacks the predetermined relation as mentioned above, the processor 204 of the called handset 116 displays a not-in-network message or equivalent, as shown at 518. Based on that information, the called party then decides at 510 whether to accept or reject the incoming call despite knowing that the call will be charged against that party's airtime.

If the comparison at 522 determines that the incoming call does include information identifying the caller's home network, the processor 204 compares that identification at 506 with the home network information of the called handset 116. If the predetermined relation is found to exist, the logic at 528 enables displaying the same-network message 508 as mentioned above. However, if the predetermined relation between home networks is not found, the logic then activates the not-in-network message 518. If no information identifying the home network of the caller is available to the called handset, the logic may activate neither message 508 or 518.

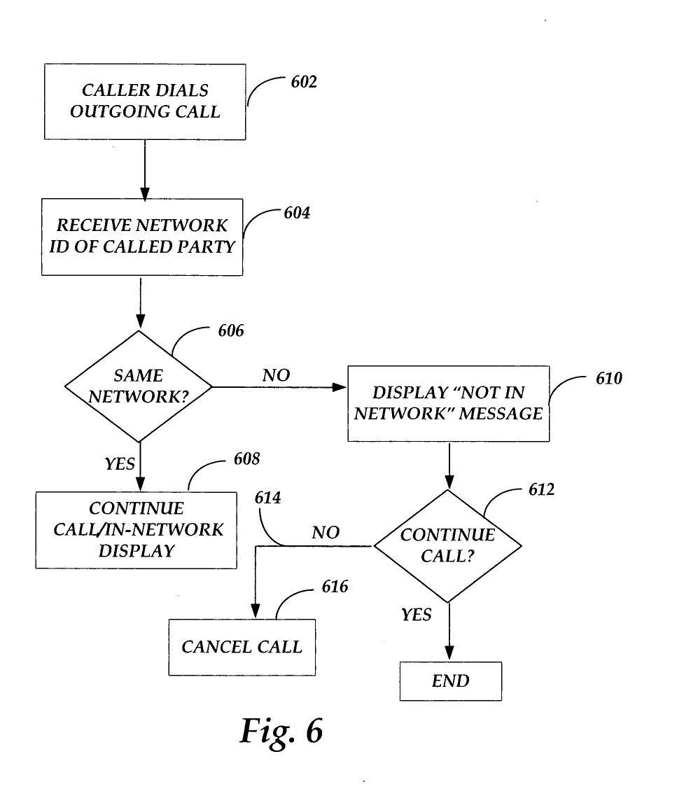

FIG. 6 illustrates exemplary logic flow performed by the processor 204 in the calling-party handset 116 in FIG. 4, according to the disclosed embodiment of the present invention. The function of such a calling handset 116, for the purposes of the disclosed embodiment, commences at 602 as a caller dials an outgoing call to the telephone number of another wireless subscriber, namely, the called party. In response to transmitting outgoing-call signaling information from the calling handset 116 to the home cellular network for that handset 116, the calling handset 116 receives at 604 the home network identification of the called party. As previously mentioned, the home network of the party being called is retrieved from a database associated, for example, with the home network of a called party, assuming the called party is presently within that home network, or from another database logically and functionally associated with the wireless network. The information identifying the home network for the called party is returned through the cellular system, possibly including the PSTN 130 as mentioned above, to the caller's handset 116 where, at 606, that home network identification is compared with the caller's home network identification, for example, previously stored in the caller's handset 116. If that comparison at 606 indicates that a predetermined relation (such as the same home network) exists between network providers for the calling and called parties, the outgoing call continues as at 608 and the calling handset 116 may optionally display a suitable indication that the outgoing call is directed to a party in the same network as the caller.

If the comparison at 606 determines that the called party does not share the same home network as the caller, or uses a home network lacking a predetermined relation with the caller's home network, then at 610 the processor displays an appropriate not-in-network message on the display of the calling handset 116. That calling handset 116 may then at 612 prompt the caller whether or not to continue the call to an out-of-network called party. If the caller decides not to continue the call, then at 614 the logic branches to 616 to discontinue further progress of the outgoing call. This act of discontinuing the outgoing call, according to the disclosed embodiment of the present invention, would end that call before the called party receives an indication of the incipient incoming call, namely, before the called handset receives a ring-enabling signal.

However, if the caller at 612 decides to continue the call to a party outside the caller's home network, the caller's handset 116 sends a signal to continue the call, thereby causing the handset 116 of the called party to ring. If that called handset 116 is equipped according to the present invention, for example, with the embodiment as described with regard to FIG. 5, the called party will see that the incoming call is not on the same home network and, thus informed, can decide whether or not to accept that incoming call.

Those skilled in the art should understand that the foregoing relates only to a disclosed embodiment of the present invention and that numerous changes and modifications therein may be made without departing from the spirit and scope of the present invention as set forth in the following claims.

What is claimed is:

1. A method for determining whether an incoming call from an originating device to a called device is originating with a predetermined home network associated with the called device, comprising:
identifying a home network for the incoming call from the originating device;
comparing the home network of the originating device with the predetermined home network for the called device; and
if the home network identified for the incoming call is determined to bear a certain relation to the predetermined home network for the called device, providing an indication of the certain relation to at least one of the called device and the originating device.

2. The method of claim 1, wherein the indication is provided at the called wireless device, enabling a user of the called device to decide whether to accept an incoming call not bearing the certain relation to the predetermined home network.

3. The method of claim 2, wherein the identity of the home network for the incoming call is obtained from a source external to the called device.

4. The method of claim 3, wherein the source comprises a database accessible to a network provider for at least one of the originating device and the called device.

5. The method of claim 1, wherein the called device identifies the predetermined home network from a source internal to the called device and receives from a source external to the called device the identity of the home network for the originating device.

6. The method of claim 1, further comprising:
providing the indication of certain relation in response to determining the same home network for the originating device and the called device.

7. The method of claim 1, wherein:
the indication of certain relation is a first kind of indication in response to determining the certain relation is present; and
providing at the called device a second kind of indication in response to determining the certain relation is absent.

8. The method of claim 1, further comprising:
providing an indication at the originating device if the certain relation is not present, so as to alert a user of the originating device that the called device and the originating device do not share the same home network.

9. The method of claim 8, wherein:
in response to determining that the certain relation is not present, the indication is provided at the originating device before ringing the called device, and
providing at the originating device an option not to complete the call to the called device, so that the originating call does not terminate to the called device as an incoming call.

10. The method of claim 1, wherein the originating device is operative for storing profiles for initiating calls from the originating device, and further comprising:
providing the indication of certain relation to the originating device in response to determining the same home network for the originating device and the called device; and
querying the profiles stored at the originating device to determine whether a profile corresponding to the called device is indicated as using the same home network as the originating device.

11. The method of claim 10, further comprising:
providing an alert signal to the user of the originating device in response to the result of the query; and.
if the called device is determined to have the same home network, updating the profile corresponding to the called device to indicate the same home network.

12. The method of claim 10, further comprising:
providing an alert signal to the user of the originating device only if the query indicates that a profile corresponding to the called device does not have the same home network.

13. In a wireless communication device operative for receiving incoming calls from either a predetermined home network for the wireless device or from a different network, the improvement comprising:
means responsive to a signal associated with an incoming call and indicating the home network for the incoming call to provide an alert indication to a user of the wireless device comparing the home network for the incoming call to the predetermined home network for the device, so that the user of the wireless device can decide whether to accept an incoming call not originating from the predetermined home network of the wireless device being called.

14. In the wireless device of claim 13, the improvement further comprising the means is operative to provide the alert indication if the home networks are the same.

15. In the wireless device of claim 13, the improvement further comprising the means is operative to provide the alert indication if the home networks are not the same.

16. A call terminating device for determining whether an incoming call from an originating device is originating with a predetermined home network associated with the call terminating device, comprising:
means for identifying a home network for the incoming call from the originating device;
means for comparing the home network of the originating device to the predetermined home network for the call terminating device; and
if the home network identified for the incoming call is determined to bear a certain relation to the predetermined home network for the called terminating device, means for providing an indication of the certain relation to at least one of the call terminating device and the originating device.
